(19) United States
(12) Patent Application Publication
(10) Pub. No.: US 2015/0235330 A1
(43) Pub. Date: Aug. 20, 2015

(54) REAL ESTATE SEARCHING SYSTEM WITH ACTIVATION CODE ENABLED CONTACTS

(71) Applicants: Stephen M. Polston, Excelsior, MN (US); Michelle Patrice Hiller, Elk River, MN (US); Hector Meneses Hernandez, Plymouth, MN (US); Jeffery Matthew Colville, Maple Grove, MN (US); Daniel Scott Cowman, Andover, MN (US); Keith Uecker, Andover, MN (US)

(72) Inventors: Stephen M. Polston, Excelsior, MN (US); Michelle Patrice Hiller, Elk River, MN (US); Hector Meneses Hernandez, Plymouth, MN (US); Jeffery Matthew Colville, Maple Grove, MN (US); Daniel Scott Cowman, Andover, MN (US); Keith Uecker, Andover, MN (US)

(73) Assignee: PREFERRED HOME BUYERS NETWORK, INC., Excelsior, MN (US)

(21) Appl. No.: 14/182,554

(22) Filed: Feb. 18, 2014

(51) Int. Cl. G06Q 50/16; G06Q 30/06

(52) U.S. Cl. CPC G06Q 50/16; G06Q 30/0625

(57) ABSTRACT

A system and method are presented to activate a real estate searching app on a mobile device through the input of an activation code. The code is associated in a database at a remote server with a first real estate professional. When the code is entered, the mobile device sends to the server the code and the current geographic location of the device. The server verifies the code to allow access to the app. The server uses the database to identify the first real estate professionals and also other professionals associated in the database with the first real estate professional. All of the identified professionals are then marketed on the mobile app. Furthermore, the server compares the time and location of the code entry with marketing events by the first professional in order to analyze the effectiveness of these marketing events.

### RELATED APPLICATIONS

The present application relates to content found in the following U.S. patent application Ser. No. 10/187,207, filed Jul. 1, 2002; Ser. No. 11/403,385, filed Apr. 12, 2006; Ser. No. 11/999,299, filed Dec. 4, 2007 (now U.S. Pat. No. 8,095,457, issued on Jan. 10, 2012); Ser. No. 13/040,314, filed Mar. 4, 2011; Ser. No. 13/071,828, filed Mar. 25, 2011; and Ser. No. 13/346,132, filed Jan. 9, 2012. Each of these related applications is hereby incorporated by reference.

### FIELD OF THE INVENTION

The present application relates to the field of computerized real estate data access system. More particularly, the described embodiments relate to a mobile device app that is customized according to a user-entered code that further serves to associate the user to other parties utilizing the system.

### SUMMARY

One embodiment of the present invention provides an app for a mobile device that is activated for use by entering a code. The code is transmitted from the mobile device to a server computer, where it is associated with a real estate related professional, such as a real estate agent or a loan officer. Information about the professional is transmitted back to the mobile app and is used to help “brand” the app for the professional. In some embodiments, the server relates the professional associated with the code with other professionals. For example, a real estate agent may be associated within a database managed by the server with a particular loan officer working for an unrelated company. In this example, the server would identify the loan officer as well as the agent to the mobile app, which would then display contact information for each of the professionals.

The app is designed to provide a branded interface that includes not only contact information for the professional but also color schemes and logos. In this way, for example, a single app on a mobile device app store can be used in connection with real estate agents that work with different—even competing—real estate companies and brokerages. The users download a single app, and the code entered by the user determines not only the professionals listed in the app but the color scheme and brokerage logos that are displayed inside the app. In the preferred embodiment, the icon displayed for the app on the mobile device operating system does not change based on the inputted code, as only the interface provided when the app is operating is customized according to the entered code.

In another embodiment, the mobile device sends to the server both the code entered by the user and the geographic location of the device when the code was entered. The information is stored in a database managed by the server. This allows the server to compare the time and location of the code entry with marketing events by related professionals, and then relate the user who made the code entry with a particular marketing event. In this manner, the server can judge the effectiveness of marketing techniques made by the professional by determining the number of users using the app that obtained their code through the marketing event.

In a further embodiment, professionals that are not working in real estate provide an app that is useful to their potential customers along with an activation code. A server tracks the time and location of app activations in order to associate the activations with a particular advertisement or marketing event.

In some embodiments, the code is not manually entered by the user but is instead associated with the request to download the app. When the download request is received, the relevant code is extracted from the download request and used to associate the app with the code. Upon use, the app presents information related to the professional associated with the code. Furthermore, the download, first use, or other activation of the app is tracked by a server to associate that particular user with a time and location, which can then be compared to marketing events or materials provided by the professional.

### BRIEF DESCRIPTION OF THE DRAWINGS

FIG. 1 is a block diagram showing the major parties using a computerized system that operates the described embodiments of the present invention.

FIG. 2 is a block diagram showing one or more server computers maintaining a computerized database to provide interaction with mobile devices and other computing devices used by the parties shown in FIG. 1.

FIG. 3 is a schematic diagram showing an app store interface on a mobile device for downloading a home searching mobile app.

FIG. 4 is a schematic diagram showing an app picker interface provided by an operating system on the mobile device.

FIG. 5 is a schematic diagram showing a sign-up interface provided by the home searching mobile app.

FIG. 6 is a schematic diagram showing a user-interface provided by the home searching mobile app that has been customized according to the code entered in the sign-up interface of FIG. 5.

FIG. 7 is a block diagram showing example data that illustrates the relationship between code entry information and marketing events.

FIG. 8 is a block diagram showing a second embodiment system database that could be used by the server computers of FIG. 2.

FIG. 9 is a schematic diagram showing a user-interface provided by the home searching mobile app that has been customized according to the code entered in the sign-up interface of FIG. 5 based on the database of FIG. 8.

FIG. 10 is a block diagram showing a third embodiment system database that could be used by the server computers of FIG. 2.

FIG. 11 is a schematic diagram showing a user-interface provided by the home searching mobile app that has been customized according to the code entered in the sign-up interface of FIG. 5 based on the database of FIG. 10.

FIG. 12 is a flow chart showing a method used by one embodiment of the present invention.

FIG. 13 is a block diagram showing a fourth embodiment system database.

FIG. 14 is a flow chart showing an alternative method.

FIG. 15 is a block diagram showing a fifth embodiment system database.

### DETAILED DESCRIPTION

### Basic Configuration 100

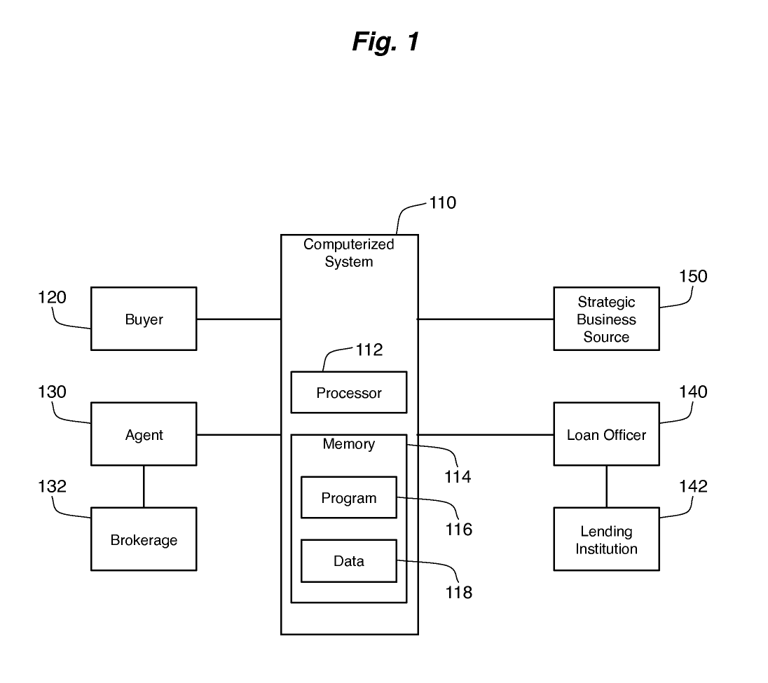

FIG. 1 is a block diagram of one embodiment of the present invention, showing a computerized system 110 for facilitating communication and business relationships between the various parties involved in the marketing and sale of real property. The computerized system 110 is designed to work with a potential buyer of real estate 120, a real estate agent 130 working with the buyer 120, and a mortgage lender or loan officer 140 who works with both the real estate agent 130 and the buyer 120. In some embodiments, a strategic business source 150 also communicates with the other parties 120, 130, 140 through the computerized system 110. Strategic business sources 150 are described in more detail in connection with related U.S. Pat. No. 8,095,457. As explained in that patent, a strategic business source 150 can be any party that may be of use to the buyer 120 in addition to the agent 130 and lender 140, such as a home inspector or moving company. Alternatively, the strategic business source 150 may be any party who would be willing to recommend that buyers 120 participate in the system 110 with a particular lender 140.

In some jurisdictions, a distinction is made between a real estate agent 130 who is licensed to sell real estate and a broker who is allowed to operate their own real estate brokerage 132 and hire additional agents to help sell real estate. Often, a brokerage 132 will hire numerous agents 130, with the agents within one brokerage 132 frequently working together to assist one another in the marketing and selling of properties listed through that the brokerage. Similarly, as shown in FIG. 1, the lender 140 usually works for (or with) a lending institution 142 that may employ multiple loan officers 140.

The computerized system 110 includes a digital processor 112 and a non-transitory, tangible memory device 114, such as a hard drive, RAM, PROM, flash memory, or some other form of programmable, physical memory. Residing on the memory 114 is a program 116 consisting of a set of instructions and interfaces for execution on the digital processor 112. Also residing on the memory is data 118, which may be organized in a structured database. Alternatively, this data 118 could be stored in a separate location accessed by the computerized system 110 over a data bus or a computer network. In most embodiments, this data 118 is stored in one or more organized databases, such as a first database to manage information about users and their preferences and a second database to search and maintain real estate listing data.

In one embodiment, the memory 114 consists of non-volatile memory, such as a hard drive or flash memory, as well as volatile memory, such as RAM. In these embodiments, the permanently stored programs 16 residing on the non-volatile memory are first loaded into volatile RAM before being processed by the processor 112. Similarly, data 118 can be stored in non-volatile memory and copied into RAM for processing by the processor 112. The processor 112 could be a microprocessor manufactured by Intel Corporation of Santa Clara, Calif., or Advanced Micro Devices, Inc. of Sunnyvale, Calif. Alternatively, the computerized system 110 could be a network of computers all operating according to the instructions of the computer program 116. The various parties 120, 130, 140, and 150 that use the computerized system 110 communicate with the system 110 through a wide area network such as the Internet.

In one embodiment, the computerized system 110 provides access to the programming 116 and data 118 by operating as a web server. The buyer 120, agent 130, lender 140 and the strategic business source 150 access the programming 116 through a web browser operating on local computing devices attached to the Internet. In another embodiment, the computerized system 110 provides access by operating as a data server that interacts with applications. In this embodiment, the system 110 operates by receiving data queries and providing the data 118 requested by the queries. The buyer 120, agent 130, lender 140, and/or the strategic business source 150 would operate applications on computing devices that interact with the computerized system 110. In some embodiments, these applications run on computer operating systems, such as MAC OS (from Apple Inc. of Cupertino, Calif.) or WINDOWS operating system (from Microsoft Corporation of Redmond, Wash.). In other embodiments, these applications take the form of small “apps” running on mobile devices operating mobile-oriented operating systems such as iOS (from Apple Inc.), WINDOWS PHONE (from Microsoft Corporation), or ANDROID (from Google Inc. of Menlo Park, Calif.). One of the major differences between these two embodiments is that the web server provides the entire user interface to the browser, while the applications or apps in the second environment implement much or most of the user interface locally and then use the dedicated data server to populate the interface with data appropriate for the user.

The various parties identify themselves to the computerized system 110 through a login process, and the server 110 presents to the user (sometimes in conjunction with a local app) an interface that is specific to the users 120, 130, 140, and 150 identified during login. Using known technologies, a computing device that has previously logged into the server 110 can be identified at a later time using cookies, and the login process can be skipped.

### Implementation of System 110

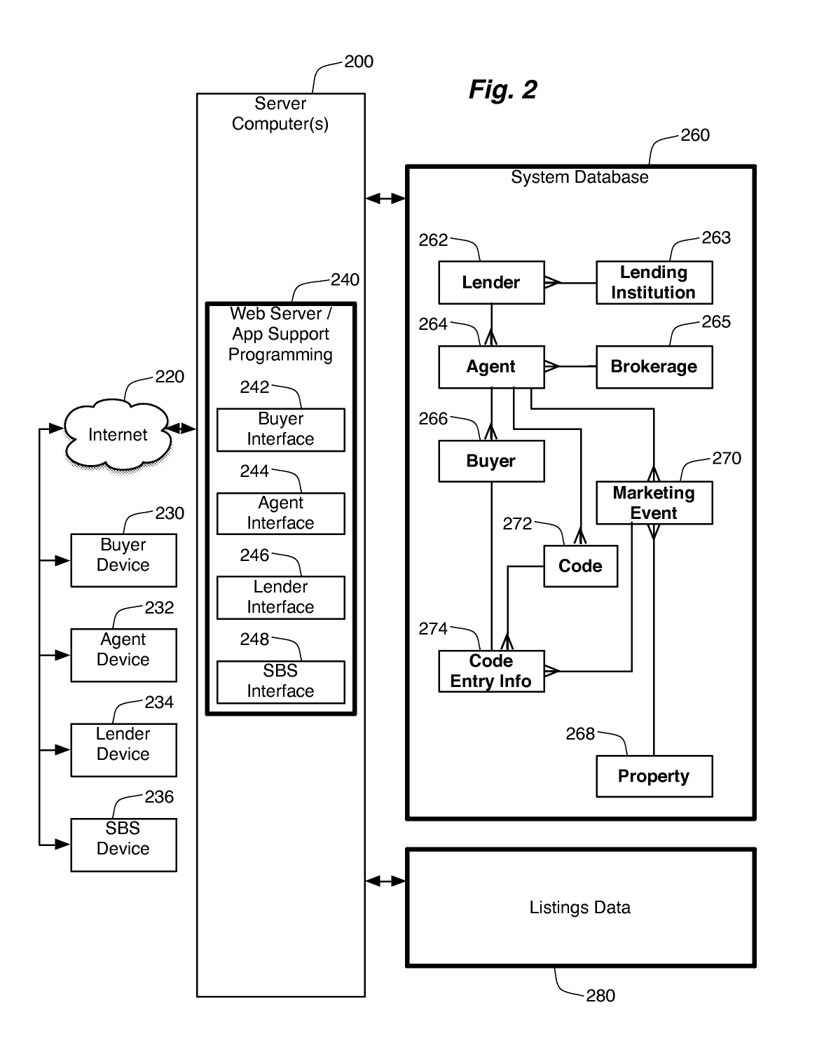

The computerized system 110 is capable of storing information about all of the parties that use the system 110. In the preferred embodiment, this information is stored in a database 260 managed by one or more server computers 200, as shown in FIG. 2. The information about the parties can be stored in pre-defined fields in a database table (or database objects in an object-oriented database environment) within the database 260. FIG. 2 shows the database with tables or objects for lenders 262, agents 264, buyers 266, and properties 268 that are listed for sale. The database 260 also includes data entities for lending institutions 263 that employ (either through legal employment relationships or through independent contractor arrangements) lenders 262 and brokerages 265 that employ real estate agents 264. Furthermore, the database 260 tracks marketing events 270 that are conducted by agents 264 for particular properties 268, and also activation codes 272 and code entry information 274 that are used to activate mobile device apps (as is described in more detail below). The dedicated platform server(s) 200 also access listing data 280, which identifies real estate properties that are available for purchase. This listings data 280 can be provided by third parties, such as a regional multiple listing service (or MLS). The listings data 280 could be integrated into the same database 260 used to maintain data 262-274 through property database entity 268, or this data 280 could be hosted by a third-party data provider with a link established between local database property entity 268 and entries in the third-party database 280.

The database 260 tracks relationships between each of the data entities 262-274, which are shown using crow's foot notation between the entities in FIG. 2. Associations or relationships between the database entities shown in FIG. 2 can be implemented through a variety of known database techniques, such as through the use of foreign key fields and associative tables in a relational database model. For instance, FIG. 2 shows that multiple agent records 264 can be associated with a lender record 262, but only a single lender record 262 is associated with any one agent record 264. This reflects the fact that the database 260 associates each agent 130 using the system 110 with a single lender 140. Similarly, the fact that buyers 120 are associated with a single agent 130 in the system 110 is implemented by associating buyer records 266 in the database 260 with only a single agent record 264. Because each buyer record 266 is associated with a single agent record 264, and each agent record 264 is associated with a single lender record 262, the database 260 also ensures that each buyer 120 is associated with a single lender 140. FIG. 260 shows an embodiment where each agent 264 is assigned at least one code 272, and each code is associated only with a single agent. Since every code entry record 274 created for a buyer record 266 will relate to a single code 272, this code entry 274 will uniquely associate that buyer 266 with a single agent record 264 in database 260.

In use, the agent associated with record 264 will publicize one of her codes 272 at a marketing event 270. Potential buyers that receive the code 272 will then use the code 272 to activate their mobile home searching app, which will cause the creation of a code entry information database entity 274. As explained before, programming may identify this code entry 274 as being associated with a particular marketing event 270. In some cases, the code will be publicized at an event that is not designed for marketing the agent or professional, such as at a convention or seminar where the professional is an attendee. The professional may still distribute their cards, and want to associate any activations using that code with this triggering event. Thus, database entry 270 need not be used only for marketing events per se, but would be equally applicable to any triggering event that is desired to be tracked.

In some embodiments, the agent 264 will be allowed to distribute multiple codes 272, each of which will be associated only with the agent 264. In this environment, the agent may have a first code for use in a publicly displayed advertising sign or signs (such as a billboard), and a second code for use with in-person contacts with potential clients (such as would occur at an open house marketing event). In this case, the code 272 itself could be used to link the marketing event data record 270 to the code entry information 274 and the buyer record 266.

FIG. 2 should not be taken to indicate that the data entities 262-274 in system database 260 need to be implemented exactly as shown, with each entity 262-274 in the Figure implemented as a single database table or object. For instance, the code entry information record 274 could easily be integrated into the buyer database record 266, while the code record 272 could be integrated into the agent record 274. FIG. 2 merely indicates that one or more database entities 262-274 can be created within database 260 to track this particular information. It is well within the scope of the prior art to implement this data using a variety of entity architectures.

Programming 240 operating on the server computers 200 uses the database 260 to implement the computerized system 110. The programming 240 operates on a processor (such as processor 12 show in FIG. 1) to generate the various interfaces used by the system 110. In particular, programming 240 defines how to create a buyer interface 242, an agent interface 244, a lender interface 246, and a strategic business source interface 248 using the data in the database 260 and in the listings data 280. This programming 240 may transmit over the Internet 220 a web-based buyer interface 242 to browser software operating on a computer 230 for the benefit of a buyer 120. Alternatively, the programming 240 may transmit data to an app operating on the buyer mobile device 230. Similarly, the programming 240 can present an agent interface 244 to an agent device 232, a lender interface 246 to a lender device 234, and an strategic business source interface 248 to an strategic business source device 236. The device 230-236 can be traditional personal computers, or can be any other type of computing device capable of presenting a web-based interface or operating Internet-based apps, including a smart phone or a tablet or netbook computer.

### Code Activated Real Estate Searching App Interfaces

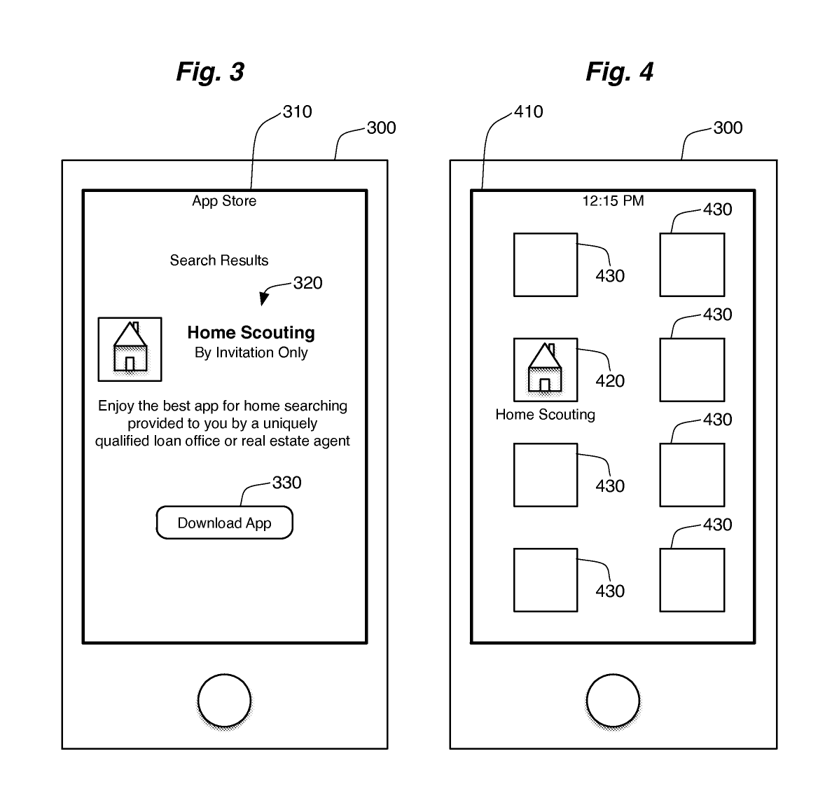

FIG. 3 shows a mobile device 300, such as a smart phone, that might be used by a buyer 120. The device 300 contains a display showing a user interface 310 for selecting and downloading apps to be used on the device 300. Both iOS and ANDROID-based mobile devices are capable of accessing an Internet based “app store.” Users search for desired apps on the app store and download selected apps directly to their mobile device. As shown in FIG. 3, the user has performed a search and found a “Home Scouting” app 320 that incorporates that present invention. The search may have been a general search for “home searching” apps, but more typically the user will conduct a search for this app by name. This is because the app 320 is an “invitation only” app, meaning that the app 320 will not run on the mobile device 300 unless the user has an activation code. As a result, most users will not download the app 320 until they have been given access to the code, either through direct contact with a real estate professional or through an advertisement or a marketing event created by the professional. The advertisement or the professional will not only provide the user with the activation code, but will also instruct the user how to download the app, usually by providing the name of the app which can be used to perform a search through interface 310.

Once the app 320 has been found through interface 310, it can be downloaded by selecting the download app button or link 330. Note that only a single app 320 is presented in the app store regardless of the different codes that might be used to download the app. As a result, agents 130 working for competing brokerages 132 and loan officers 140 working with a variety of independent lending institutions 142 will all refer potential buyers 120 to the same app 320 on the app store 310. This requires that the app 320 be advertised and described in a generic manner on the app store 310 rather than marketing the app 320 as associated with a single company 132, 142.

Once the app 320 is downloaded, it is presented to the user of the mobile device 300 on the home page or app selector interface 410 of the mobile device 300 as shown in FIG. 4. This Figure shows an icon 420 for the app 320 being displayed among a plurality of other icons 430 on interface 410. As was the case with the search results shown on app store interface 310, the icon 420 shown in the app selector interface 410 is generic regardless of which professional 130, 140, 150 provided the code to unlock the app 320. This remains true even after the app 320 is unlocked.

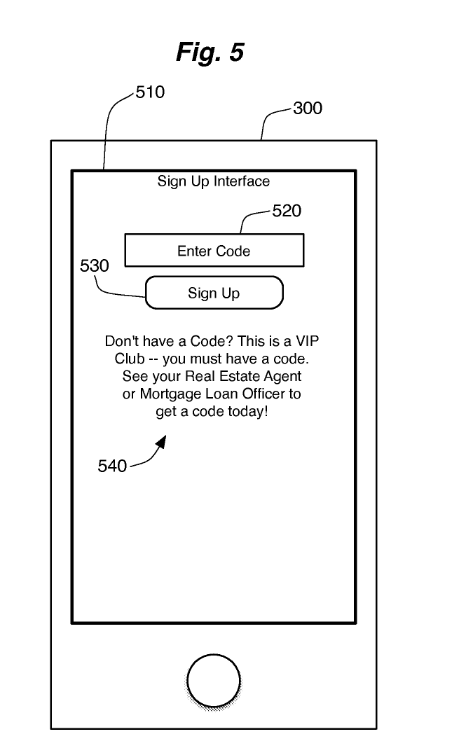

The first time the user opens the app 320 (such as by selecting icon 420 in interface 410), the sign up interface 510 is presented as shown in FIG. 5. This interface 510 provides a field 520 into which a user can input an unlock code for the app 320. Once the code is entered into this field 520, the user presses the “sign up” button or link 530 to activate the app 320. In the preferred embodiment, the sign up interface 510 includes an explanation 540 that informs the user that the app 320 cannot be utilized unless a code is entered that has been provided by a real estate professional known to the computerized system 110.

Once the code is entered, the app 320 will transmit the code to the computerized system 110 for verification. In the preferred embodiment, the app 320 will also request permission from the user to share the present geographic location of the mobile device 300 with the system 110. The system 110 will verify that the entered code 272 is present in its database 260, and then link the user's buyer database entity 266 with the professional 264 associated with that code 272. The system 110 may request that the user provide information about himself or herself to aid in the population of the buyer data record 266, and then create the buyer record 266 and the code entry data record 274 for this app activation. If the user allowed the communication of the location of the device 300 at the time of activation, this information will be included in the code entry information data record 274. The code entry record 274 will be linked to the code 272 used to activate the app 320, which will allow the system 110 to link the newly created buyer record 266 with the record for the real estate professional 264 that is associated with that code 272. In this case, the buyer record 266 is associated with an agent record 264. Since the agent record 264 will be associated with a lender or loan officer record 262, this record 262 is also associated with the buyer record 266.

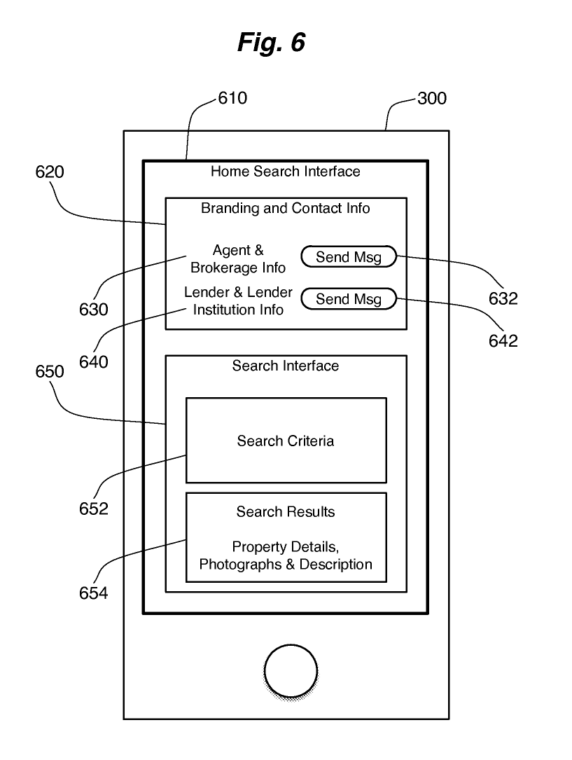

Assuming that the code entered into field 520 is accepted as valid by the system 110, the app 320 will respond by providing the home search interface 610 to the user, as shown in FIG. 6. This interface 610 consists of a branding and contact information section 620, and a search interface section 650. The branding and contact information section 620 includes information 630 about the agent and the agent's brokerage taken from the agent 264 and brokerage 265 database entities that are linked in the database 260 with the buyer record 266 for the current user. This section 620 also includes information 640 about the lender and lender institution taken from the lender 262 and lender institution 263 database records that are also linked in the database 260 with the user's buyer record 266 (through the agent record 264). In one embodiment, this section 620 also includes contact links 632, 642 for the described agent and loan officer, respectively. The contact links 632, 642 may be phone numbers that can be dialed by the mobile device 300 by simply selecting the links 632, 642. Alternatively, the links 632, 642 may open up detail pages for the professional revealing multiple contact methods that may be executed on the mobile device 300, such as an instant message link, an e-mail link, or even a link to a proprietary message system maintained by the system 110 using its database 260 (as is described in more detail in the incorporated patent applications). The branding and contact information section 620 will also include logos, trademarks, and color schemes that are associated with one of the agent 264, brokerage 265, lender 262, or lending institution 263. The search interface 650 allows a user to enter search criteria 652 and see the results 654 of the search in the form of property details, photographs, and descriptions.

One of the features of this interface 610 is that the agent 130, the agent's brokerage 132, the loan officer 140, and the loan officer's lending institution 142 are all prominently promoted to the potential buyer 120 when they use the app 320. The selection of these different entities 130-142 for promotion on the app interface 610 is based upon the code 272 entered by the user and the relationships previously established within the database 260.

### Marketing Event Identification for Code Entries

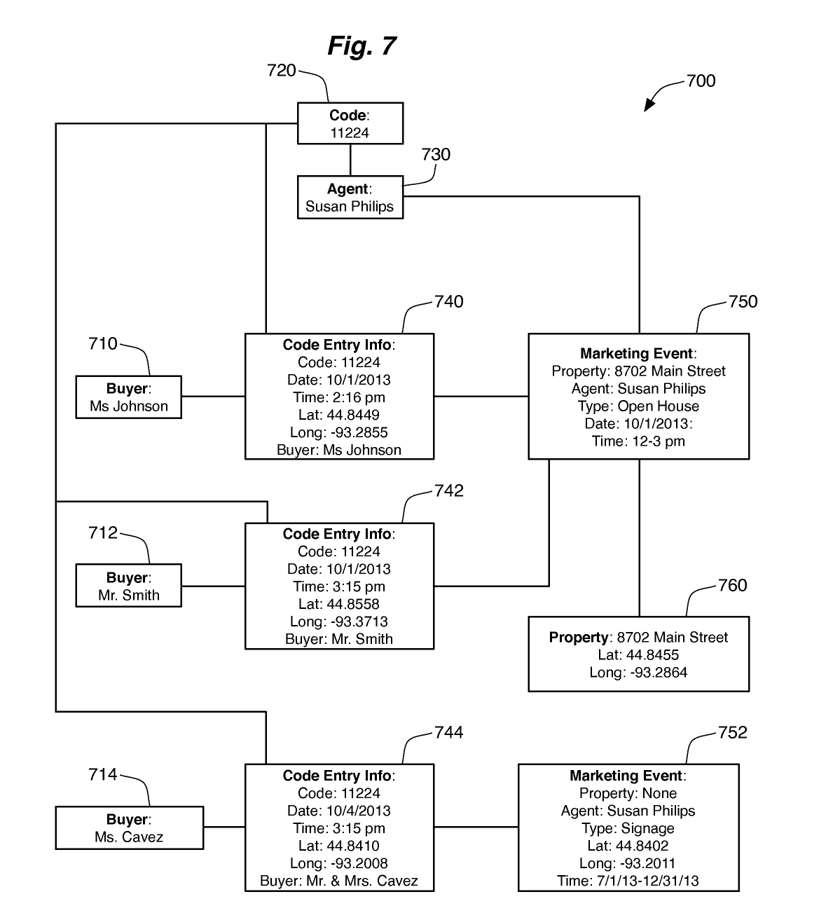

As explained above, the sign up interface 510 may send both the code input by the buyer in field 520 and the geographic location of the mobile device 300 to the computerized system 110 during activation of the app 320. This allows the system 110 to add this information into the code entry info database entity 274 for that user. FIG. 7 shows sample data 700 that takes advantage of this feature to help associate marketing events with new users of the home searching app 320.

In FIG. 7, three buyers, Ms. Johnson 710, Mr. Smith 712, and Ms. Cavez all entered the same code “11224” (code 720) when activating the app 320. This code 720 is associated with a real agent 730 named Susan Philips. When Ms. Johnson 710 entered the code 720, a code entry information record 740 was created. As shown in FIG. 700, this record 740 indicates that Ms. Johnson entered code 11224 on Oct. 1, 2013 at 2:16 pm. When the code was entered, Ms. Johnson's mobile device could be found at a geographic location having a latitude of 44.48449 degrees and a longitude of −93.2855 degrees. For purposes of this example, it is assumed that Ms. Johnson met agent Susan Philips at an open house located at 8702 Main Street. The open house occurred on Oct. 1, 2013 from 12 pm to 3 pm. Agent Philips told Ms. Johnson about the app 320 when they met at the open house, and instructed her to use activation code “11224.” Ms. Johnson left the house and went to her car across the street, where she downloaded the app and entered code 11224 at 2:16 pm. Similarly, Mr. Smith 712 met agent Susan Philips 730 at the same open house and received the same information. Mr. Smith, however, drove to his home across town and then downloaded the app and entered the code at 3:15 pm.

Because the database 260 contains information about the open house marketing event 750 and the related property 760, the programming 116 used by the computerized system 110 is able to associate both Ms. Johnson 710 and Mr. Smith 712 with this open house event 750. In the case of Ms. Johnson 710, her activation code entry 740 took place during the same time frame as the marketing event 750 (namely between 12 pm and 3 pm on Oct. 1, 2013) at almost the exact same physical location (across the street). Because of these similarities, the programming was able to create a link or association in the database 260 between the code entry information 740 and the marketing event 750. The relationship between the code entry record 742 of Mr. Smith 712 and the open house marketing event 750 was not as easy to spot. The geographic location of the code entry 742 was not near the marketing event 750, but the time of the code entry 742 (3:15 pm on Oct. 1, 2013) occurred soon after the termination of the open house event 750. In this case, business rules were used to determine whether a particular code entry 742 should be associated with the event 750. In the example of an open house event, such as event 750, it may be assumed that all code entries during the event or within a few hours (such as six hours) after the event should be associated with the event 750 regardless of the geographic location of the code entry.

While Ms. Cavez also entered code 11224, her code entry record 744 indicated that she entered the code three days after the open house event 750 and was not located near the property 760 at that time. As a result, this code entry record 744 would not be associated with the open house marketing event 750. However, the programming 116 was able to determine that Ms. Cavez was very near an advertising sign of agent Susan Philips 730 when Ms. Cavez entered activation code 11224. This sign may take the form of a billboard, a bus stop sign, or a for sale sign, and may include the activation code on the sign itself. The database 260 includes a marketing event database entity 752 for that sign indicating the geographic location for the sign and the duration that the sign was present at that location. Because the code entry info database entity 744 corresponds to the geographic location and time frame of the signage marketing event 752, this code entry entity 744 is associated with this marketing event 752 in the database 260.

The linkages or associations created between these data elements 700 not only associate the buyers 710-714 with real estate agent Philips 730, but also serve as a technique for measuring the effectiveness of various marketing activities 750, 752. Because of the computerized system 110, Susan Philips knows that her open house generated two new users 710, 712 of the app 320, who now will view her contact information 630 every time they conduct a home search using the app 320. Furthermore, she knows that the sign represented by marketing event database entity 752 generated a lead in the form of Ms. Cavez 714 on Oct. 4, 2013. By tracking all of the marketing activities of a variety of agents, the computerized system 110 will be able to identify which agents are most effectively marketing themselves and their brokerage, and which types of marketing events are most effective. Furthermore, the system 110 may be able to identify which types of advertisements are most cost effective in terms of leads generated, and which geographic locations are best suited for different types of advertising signs.

In another embodiment, Agent Susan Philips is able to distribute multiple codes 720. Each of these codes 720 is uniquely assigned to her 730, and each could be pre-assigned to a single marketing/trigger event, such as the open house 750 or the sign 752. In this embodiment, it would not be necessary to use the time or geographic information in the code entry information 740-744 to identify the appropriate marketing event 750, 752 for that activation. While using separate codes for each marketing event 750, 752 ensures accurate associations between code entries 740-744 and marketing events 750, 752, this embodiment complicates the process used by the agent 730 as she must create and assign new codes 720 for each new marketing event 750, 752.

### Alternative Embodiments

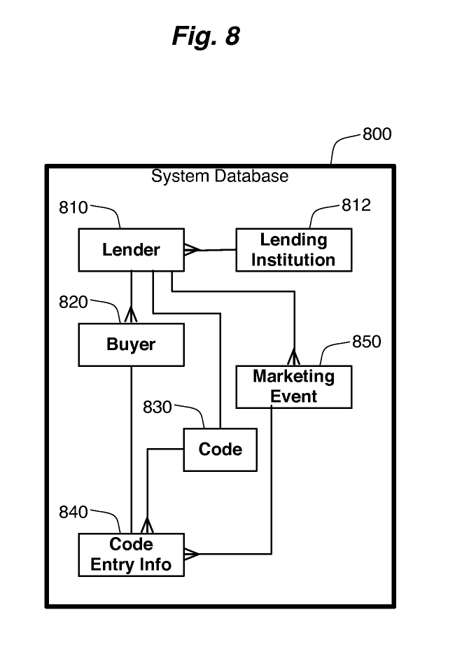

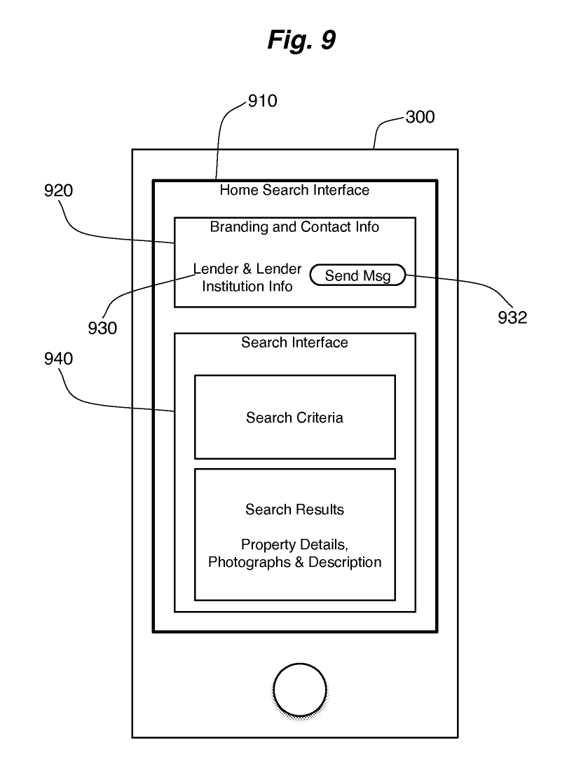

FIG. 8 shows an alternative arrangement for the system database 800, in which a lender database record 810 is directly associated with a buyer database record 820 without the need for that association to pass through an agent database record (which is not shown in FIG. 8). This embodiment can be used when a loan officer directly distributes activation codes to potential buyers for use with the home searching app 320. When the buyer enters the lender-provided code, the buyer record 820 and code entry information record 840 are created as was described above in connection with database 260. In this case, the code entry info record 840 indicates that the buyer entered a code 830 that is associated in the database 800 directly with the lender 810. When a lender-affiliated code is used to activate the app 320, the home search interface 910 does not include branding and contact information for an agent, as shown in FIG. 9. Rather, the branding and contact information section 920 of the search interface 910 will only disclose information 930 about the lender 810 and his or her lender institution 812, and will include only a contact link 932 for that lender. The search portion 940 of interface 910 will remain the same as the search portion 650 of interface 610.

In addition to allowing lender specific activation codes 830, the database arrangement of FIG. 8 also allows the tracking of marketing events 850 that are created by the lender 810. These may include first time buyer seminars put on by the lender, or advertisements and signs promoting the lender and his or her lending institution. Code entry information database entities 840 associated with lender codes 830 can be associated with these database entities 850 for the marketing events in the same way described above for real estate agent marketing. This would allow the system to track the effectiveness of the lender's different marketing activities.

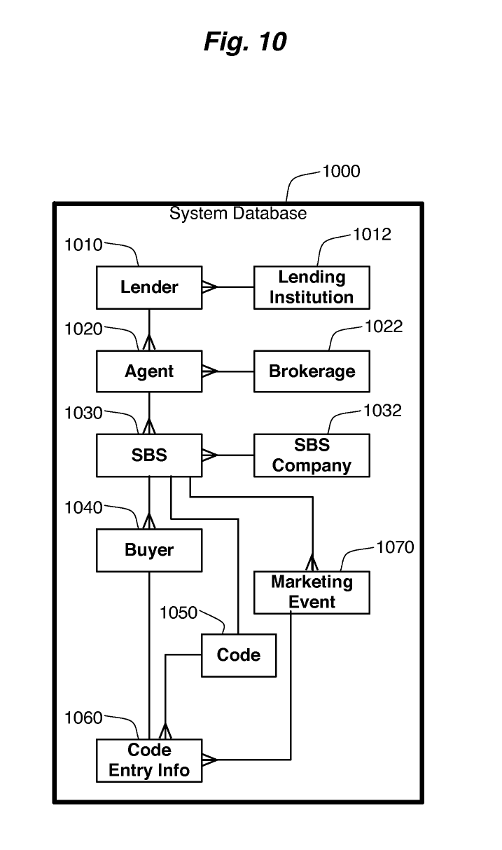

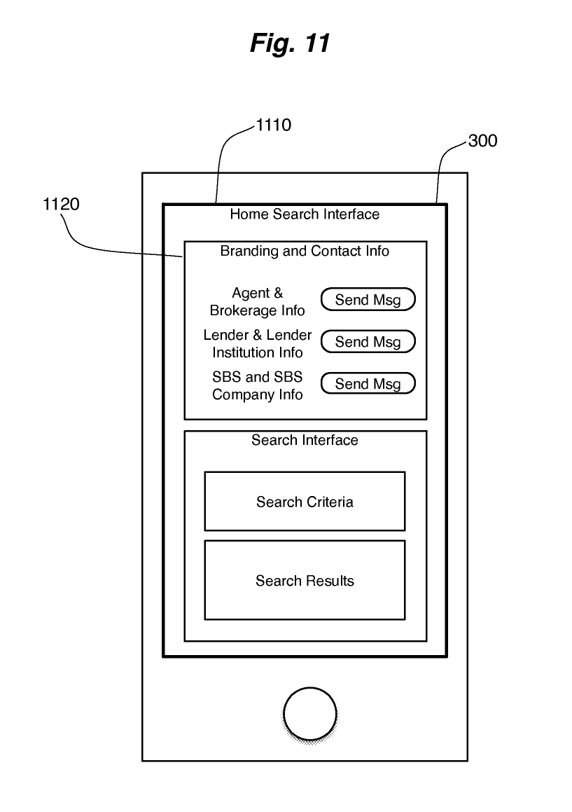

FIG. 10 shows a third alternative arrangement for the system database 1000 in which a strategic business source (identified through database entities 1030) distributes their own activation codes (database entities 1050). In this case, the database 1000 can associate buyers 1040 and their activation code entries 1060 directly with the strategic business sources 1030 through the codes 1050. In FIG. 10, each strategic business source 1030 is associated with a particular agent 1020, and each agent 1020 is in turn associated with a particular lender 1010. Thus, by entering a single code 1050, each buyer entity is associated with a strategic business source 1030 and the related strategic business source company 1032, a real estate agent 1020 and the related brokerage 1022, and a loan officer 1010 and the related lending institution 1012. When the user activates the app 320 by entering a code 1050 provided by a strategic business source, the resulting home search interface 1110 shown in FIG. 11 will include information about and contact links for all of these entities 1010, 1012, 1020, 1022, 1030, and 1032. This database 1000 also tracks marketing events 1070 for the strategic business source 1030 and associates these events 1070 with the buyer code entries 1060 in the same manner described above, so that the effectiveness of the strategic business source's marketing efforts can also be tracked.

It is possible in database 1000 that the strategic business source database entity 1030 is not associated with an agent database entity 1020 but instead is directly associated with a lender database entity 1010. In this case, buyers that enter a code provided by the strategic business source would be linked to the strategic business source 1030 and the lender 1010 but not to any particular real estate agent. In this circumstance, interface 1110 should present information from the strategic business source 1030, the strategic business source company 1032, the loan officer 1010, and the lending institution 1012, without providing any information about a real estate agent 1020 or a brokerage 1022.

Although database 260, 800, and 1000 were described above as alternative embodiments, it is possible that all three of these configurations of data could co-exist within a single database. Activation codes within this single database could be associated with a real estate agent, a lender, or a strategic business source. The home search interface presented to a particular buyer would then depend on which type of real estate professional distributed the code used by that buyer.

### Method

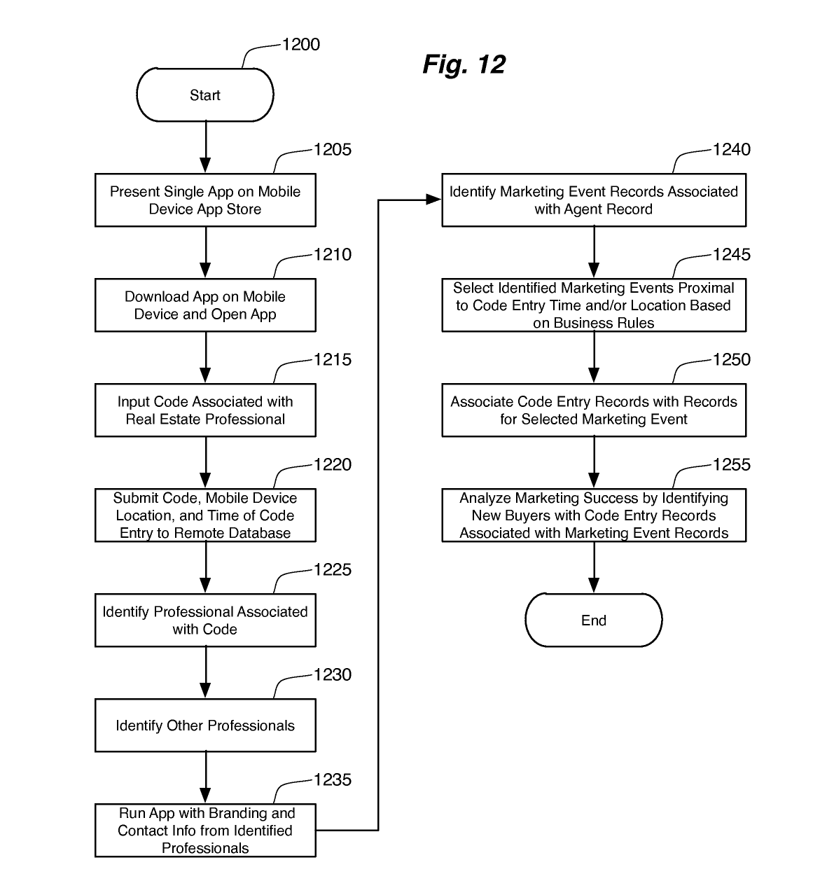

FIG. 12 shows a method 1200 for implementing one embodiment of the present invention. The method 1200 starts at step 1205, in which only a single app 320 is presented to users for download via a mobile device app store. This means that it is not necessary for each lending institution 1012, brokerage 1022, or strategic business source company 1032 to create, maintain, and market their own home searching app on the app store.

When the user has received an activation code and instructions on where to find the app, the user can then download the app and open the app on their mobile device (step 1210). When the app is opened, it will request that the user enter the activation code that was provided by their real estate professional. When this code is entered into the app, the app will send the code to the remote computerized system 110 for verification in step 1220. In the preferred embodiment, the app will also determine the current location of the mobile device and submit this location information to the computerized system 110 along with the entered code information. The mobile device may also send the date and time that the code was entered. Alternatively, this information could be determined by the remote computerized system by simply noting the time at which the code submission was received.

At step 1225, the remote system 110 will then use the activation code to identify the real estate professional that provided the code. In the example of database 260, this would be a real estate agent 130, but it could also be a loan officer 140 or a strategic business source 150. At step 1230, the system 110 will identify other professionals who should also be marketed based on the professional that provided the code. In the example of database 260, the loan officer associated in the database 260 with the real estate agent that provided the code would be identified in step 1230. In the example of database 1000, both the agent and the loan officer associated in the database 1000 with the strategic business source that provided the code would be identified in step 1230. At step 1235, the activated app is operated on the mobile device to allow the user to search for home listings. The app is operated while providing contact information, logos, and color schemes determined by the identifications made in steps 1225 and 1230.

At step 1240, the system 110 will identify marketing events that are associated with the professional that provided the activation code. This is accomplished by locating database records for marketing events that are associated in the database with the record for that professional. Next, step 1245 compares these marketing events with the time and location at which the user entered their activation code to determine which marketing events match the activation code entry data. The criteria as to when a marketing event matches an activation code entry event can be based on business rules that vary depending on the type of marketing event. For instance, open house marketing events may match against any code entry that takes place in a wide geographic area (i.e., an entire metropolitan area) and take place during or immediately following the time frame of open house. Signage marketing events may have a very long time frame, and may match against any code entry event that takes place while the sign is being display and within a small geographic area surrounding the sign (i.e., 500 feet). Alternative business rules may limit the geographic area for open house events to a few blocks from the location of the open house and allow matches only for code inputs that took place during the timeframe of the open house. Once marketing events are found that match the details of the activation code entry, step 1250 associates the database entities for those marketing events with the database entity for the code entry information.

As described above, in some embodiments a single professional will be associated with multiple activation codes. Each of these codes could be associated with a separate marketing event. In these circumstances, steps 1240-1250 can be greatly simplified, as each code could be directly associated with a separate marketing event.

At step 1255, the computerized system 110 analyzes all of the marketing event database entities and determines which events are more successful than others. This is accomplished by determining which events are associated with more potential buyers based on the database associations created in step 1255. The number of associations for each event can be considered a score or success value for that event. The success of events can be compared to other events based on time-of-day, geographic location, organizing professional, or any other information stored in the database concerning these marketing events. After step 1255, the method 1200 terminates.

### Further Alternative Embodiments

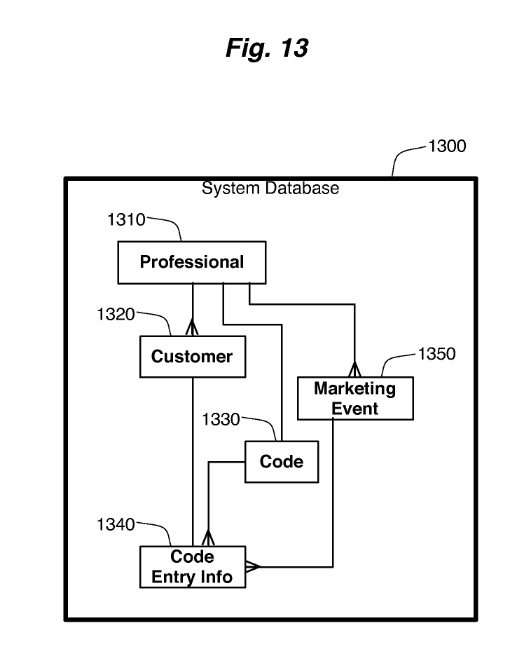

FIG. 13 shows a fourth alternative arrangement for system database 1300. In this arrangement 1300, professionals who may not be associated with the real estate industry (identified through database entities 1310) distribute their own activation codes (database entities 1330). The professional may be, for example, an attorney, an accountant, or a financial advisor. The professional uses advertisements or other marketing events (tracked through database entities 1350) to market their products or services to customers (entities 1320). In these advertisements or marketing events, the professional encourages the potential customer to download an app for their mobile device. For instance, an attorney may encourage a potential customer to download a legal-related app, or the accountant or financial advisor may encourage the potential customer to download a financial management app. As was the case with the above embodiments, these apps cannot be used until the user inputs an activation code 1330. The professional provides the potential customer with the code 1330 that is associated with the professional. When the customer enters the code 1330 during activation of the app, information about the time and location of the customer's mobile device during code entry is uploaded to a computerized system 110 and stored in database entity 1340. The code 1330 is used to associate the customer's app with the professional that provided the code, allowing the app to display contact information and other branding and advertising information associated with the professional whenever the app is used by the customer. The code entry information database entity 1340 is then associated with a marketing event or advertisement 1350 of the professional, allowing the professional to track the effectiveness of their marketing.

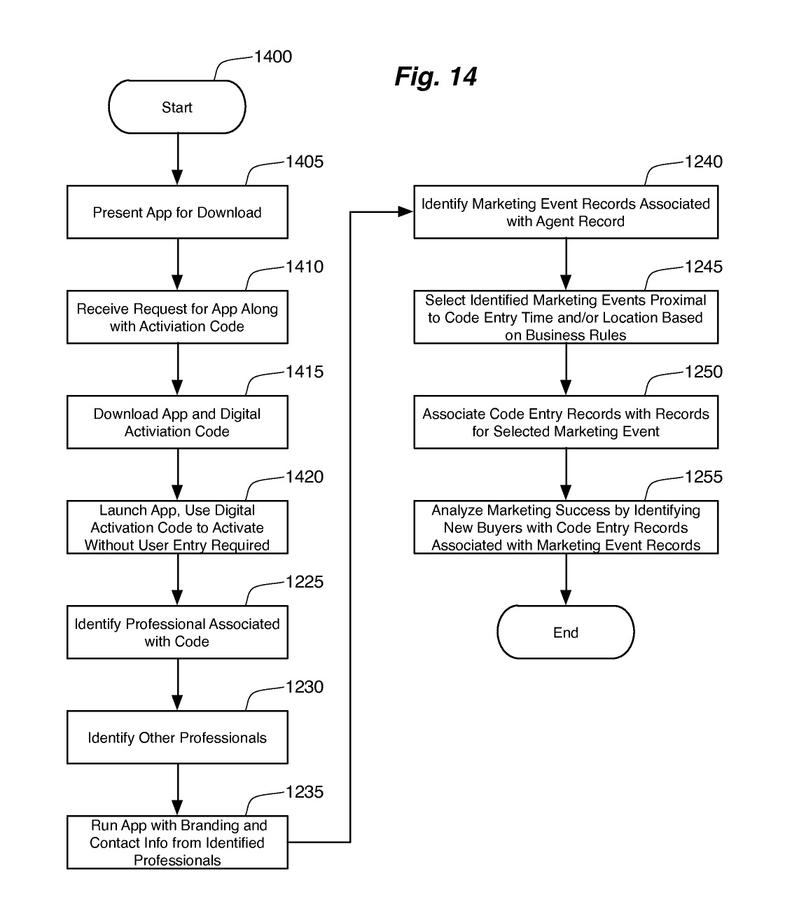

The flowchart shown in FIG. 14 describes an alternative method 1400 that may be used with any of the previously described embodiments of the present invention. In this method, a generic app is made available for download at step 1405. The app is “generic” in that it is not associated with a particular professional or organization. The app can be made available for download at an “app store” associated with a particular mobile device operating system. Alternatively, the generic app can be made available for download over a network through a website, an FTP site, or through any known method of downloading software.

At step 1410, the server or computer that makes the app available for download receives a request to download the app from a mobile device. This request includes the activation code that will be used to activate the app. For instance, a URL address could be submitted in order to indicate that the app should be downloaded. In this case, the activation code could be sent along as a data parameter within the URL.

At step 1415, the app is downloaded from the server or computer to the requesting mobile device. In addition, the activation code is also downloaded in a digital format along with the app. In some embodiments, the activation code could accompany the app as part of the app's metadata. In other embodiments, the app's programming code could be altered immediately prior to download to incorporate the activation code within the code itself. In either case, when the user first launches the app on a mobile device (step 1420), the app will automatically locate the activation code and use that code to activate the app. This is accomplished without requiring the user to manually enter an activation code into the app. After this step 1420, the method 1400 continues with step 1225 to step 1255, as described above in connection with FIG. 12. Of course, if the user did not provide an activation code at step 1410, the app could still be downloaded without such a code at step 1415. In this case, the app would then request entry of such a code during an initial use by the user as described in connection with method 1200.

The primary benefit of method 1400 is that the user is no longer required to remember and manually enter an activation code. Instead, the technique used by the professional to identify the app for download to potential customers could itself incorporate the activation code. For example, a professional may distribute cards at a marketing event containing a QR code. The QR code could encode the location for downloading the desired app along with the activation code associated with the professional. By simply scanning the provided QR code, the user's mobile device would be directed to the download location of the desired app and the activation code would be automatically provided as required by step 1410.

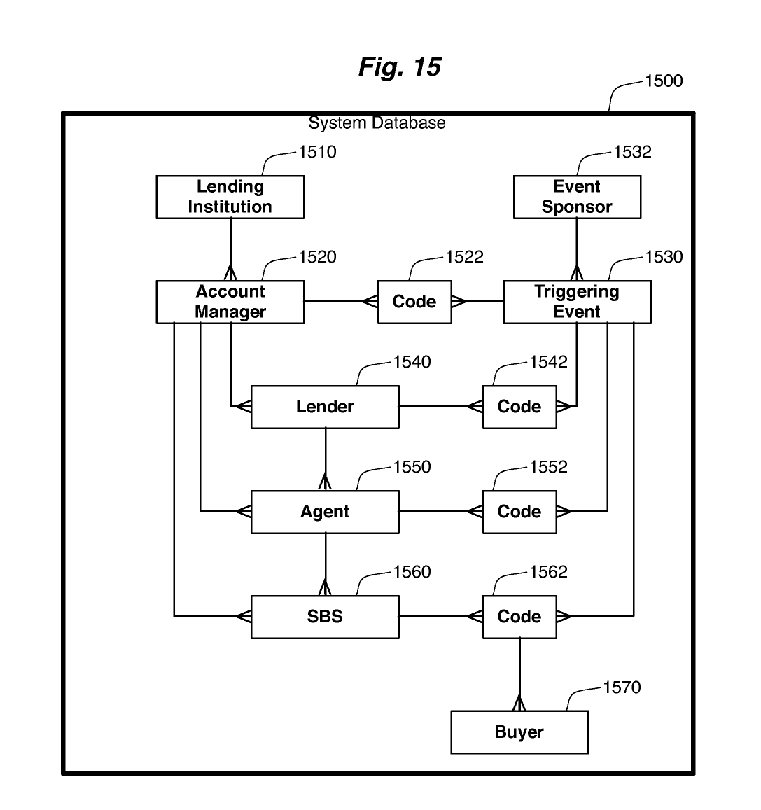

FIG. 15 shows yet another alternative arrangement for a system database 1500. In this arrangement 1500, a lending institution (associated with database entry 1510) has appointed a plurality of account managers (database entity 1520) to market a real estate mobile app and otherwise develop business for the lending institution. To assist the account manager in tracking the number of potential buyers that are using the app as a result of their efforts, each account manager 1520 may be assigned one or more activation codes 1522 that are uniquely associated with them in the database 1500. In this embodiment, each code 1522 can be assigned to a separate marketing or triggering event 1530, so that each time the code 1522 is entered, the code 1522 alone can be used to identify the triggering event 1530. In this embodiment, the triggering event 1530 may not be a marketing event created or paid for by the account manager 1520, but may instead be an event sponsored by an unrelated event sponsor 1532. For instance, the triggering event 1530 may be a trade show, a union meeting, or an employee get-together, with the event sponsor 1532 being a trade organization, a union, or an employer, respectively. In order to encourage event sponsors 1532 to allow distribution of the codes 1522 at their events 1530, the activated mobile app can be programmed to present information about the event sponsor 1532 to users every time the app is operated. Thus, if a potential customer were to enter an account manager's activation code 1522 that is associated with a particular triggering event 1530, information about both the lending institution 1520 employing the account manager 1522 and the event sponsor 1532 would be presented to the customer whenever the customer used the app.

In the embodiment shown in FIG. 15, database entities for loan officers 1540, real estate agents 1550, and strategic business sources 1560 are all directly associated with the account manager 1520. This represents the situation where an account manager recruits loan officers, agents, and strategic business sources to encourage buyers to utilize the real estate mobile app. In an alternative embodiment, the account manager 1520 could exist outside the lender/agent/SBS hierarchy (shown without an account manager in FIG. 10 as part of database 1010), with none of these entities 1540, 1550, 1560 being associated with any account manager 1520. In this embodiment, the lender 1540 and the account manager 1520 would both be associated with a particular lending institution 1510, but not with each other. Regardless of where the account manager 1520 fits in the lender/agent/SBS hierarchy, each professional 1520, 1540, 1550, 1560 is associated with their own set of activation codes 1522, 1542, 1552, 1562, respectively. Furthermore, each of these codes 1522, 1542, 1552, 1562 can be associated with a triggering event 1530 and an event sponsor 1532.

A buyer 1570 can enter any of code 1522, 1542, 1552, 1562 to activate the mobile app, even though FIG. 15 shows the buyer entity 1570 only being associated with the SBS codes 1562. Upon entry of the code 1522, 1542, 1552, 1562, the buyer 1570 will be associated with a professional 1520, 1540, 1550, 1560 directly associated with that code 1522, 1542, 1552, 1562, and any entity above that professional in the hierarchy. For instance, an SBS code 1562 can associate the buyer 1570 with the SBS 1560, the agent 1550 working with the SBS 1560, the lender 1540 working with that agent 1550, the account manager 1520, and the lending institution 1510. The buyer 1570 would also be associated with the triggering event 1530 associated with that code 1562, and the event sponsor 1532 that sponsored or organized that event 1530. During use of the app, each of these entities 1510, 1532, 1540, 1550, 1560 may be prominently displayed to the buyer 1570 and assist the buyer 1570 during use of the app. Note that the account manager 1520 may not be displayed to the buyer 1570, as the account manager would likely not be in a position to provide services directly to the buyer 1570.

FIG. 15 shows that each code 1522, 1542, 1552, and 1562 is directly associated with a triggering event 1530. This means that a new code would be needed for each professional 1520, 1540, 1550, 1560 for each marketing or triggering event 1530 where the codes 1522, 1542, 1552, 1562 are being distributed. It would be within the scope of this invention to assign each professional 1520, 1540, 1550, 1560 fewer codes (or even a single code), and then use the processes described above (such as method 1200) to relate a code entry to a particular triggering event. Once the activation code entry is associated with a particular triggering event 1530, the event sponsor 1532 can then be promoted to the user during use of the mobile app.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A server comprising:
a) at least one computer, each computer having a processor that processes programming instructions;
b) a first non-transitory computer readable memory containing data in a database, the database containing:
i) an agent record containing information about a real estate agent,
ii) a buyer record containing information about a potential buyer of real estate working with the real estate agent, the buyer record being associated with the agent record,
iii) a code entry record containing information about the entry by the potential buyer of a code that is associated with the agent record, and
iv) a triggering event record containing information about a triggering event associated with the agent record, the triggering event record containing at least one of a event time and an event location for the triggering event; and
c) a second non-transitory computer readable memory containing programming for:
i) receiving a code from the potential buyer over a computer network,
ii) recording the fact that the potential buyer associated with the buyer record entered the code in the code entry record,
iii) associating the code with the agent record,
iv) establishing a link between the buyer record and the agent record based on the association between the code and the agent record, and
v) associating the triggering event record with the code entry record based on similarities between the code-entry record and the triggering event record.

2. The server of claim 1, wherein the second non-transitory computer readable memory further contains programming for recording a code-entry time into the code entry record.

3. The server of claim 2, wherein the similarities between the code-entry record and the triggering event record are determined by comparing the code-entry time to an event time in the triggering event record.

4. The server of claim 3, wherein the second non-transitory computer readable memory further contains programming for receiving a code entry location from the potential buyer over the computer network and recording the code-entry location into the code entry record.

5. The server of claim 4, wherein the similarities between the code-entry record and the triggering event record are further determined by comparing the code-entry location to an event location in the triggering event record.

6. The server of claim 1, wherein the second non-transitory computer readable memory further contains programming for receiving a code entry location from the potential buyer over the computer network and recording the code-entry location into the code entry record.

7. The server of claim 6, wherein the similarities between the code-entry record and the triggering event record are determined by comparing the code-entry location to an event location in the triggering event record.

8. The server of claim 1, wherein the second non-transitory computer readable memory further contains programming for analyzing the success of the triggering event by counting code entry records associated with the triggering event record.

9. The server of claim 8,
wherein the database contains a plurality of triggering event records;
wherein each triggering event record contains information identifying one of a plurality of marketing types;
wherein a plurality of code-entry records are associated with the plurality of triggering event records; and
further wherein the second non-transitory computer readable memory further contains programming for analyzing the success of the marketing types in a geographic area by counting code entry records associated with the triggering event records for each of the plurality of marketing types.

10. A computer implemented method comprising:
a) downloading a generic home searching app from a mobile app store to a first and a second mobile device;
b) submitting a first code through the first mobile device to a server computer to unlock access to the home searching app on the first mobile device;
c) at the server computer, associating the first code with a first real estate agent working for a first brokerage company;
d) displaying contact information for the first real estate agent on the first mobile device when providing access to the search capabilities of the home searching app;
e) submitting a second code through the second mobile device to the server computer to unlock access to the home searching app on the second mobile device;
f) at the server computer, associating the second code with a second real estate agent working for a second brokerage company;
g) displaying contact information for the second real estate agent on the second mobile device when providing access to the search capabilities of the home searching app;
h) entering a second code in the second mobile device to unlock access to the mobile home searching app on the second mobile device; and
i) displaying the same home searching app icon on displays of the first and second mobile device even though the first and second real estate agents work for different brokerages.

11. The computer implemented method of claim 10, further comprising altering the colors presented on the displays of the first and second mobile device based on colors associated at the server computer with the first and second brokerage companies.

12. A computer implemented method comprising:
a) downloading a generic home searching app from a mobile app store to a mobile device;
b) submitting a code through the mobile device to a server computer to unlock access to the home searching app on the first mobile device;
c) at the server computer, querying a database to associate the code with a real estate agent;
d) at the server computer, querying a database to associate the real estate agent with a loan office; and
e) displaying contact information for the real estate agent and the loan office on the mobile device when providing access to the search capabilities of the home searching app.

13. The computer implemented method of claim 11, further comprising:
f) at the server computer, querying the database to associate the real estate agent with a brokerage company, wherein the identity of the brokerage company is displayed on the mobile device when providing access to the search capabilities of the home searching app.

14. The computer implemented method of claim 11, further comprising:
g) at the server computer, querying the database to associate the loan officer with a lending institution, wherein the identity of the lending institution is displayed on the mobile device when providing access to the search capabilities of the home searching app.

15. A computer implemented method comprising:
a) at a server computer, receiving from a user using a remote mobile device a code and a location at which the code was used to activate an app running on the mobile device;
b) at the server computer, using the code to query a database to identify a professional record;
c) at the server computer, using the identified professional record to query a database to identify associated triggering event records;
d) at the server computer; comparing the associated triggering event records to the data received from the remote mobile device to identify a responsible triggering event record; and
e) at the server computer; associating a user data record in the database for the user with the responsible triggering event record.

16. The server of claim 15, wherein the responsible triggering event record is identified based on comparing the location at which the code was input and a location associated with the responsible triggering event record.

17. The server of claim 16, wherein the responsible triggering event record is identified further based on comparing a code entry time received from the user and an event time associated with the responsible triggering event record.

18. The server of claim 15, further comprising:
f) at the server computer, analyzing a success value for the responsible triggering event by counting a total number of user data records associated with the responsible triggering event record.

19. The server of claim 15, wherein the code was manually input into the remote mobile device by the user to activate the app.

20. The server of claim 15, wherein the code was provided during download of the app based on a download request received from the remote mobile device, further wherein the code was automatically used to activate the app without requiring the user to manually input the code into the remote mobile device.

21. A server comprising:
a) at least one computer, each computer having a processor that processes programming instructions;
b) a first non-transitory computer readable memory containing data in a database, the database containing:
i) a professional record containing contact information about a professional,
ii) a customer record containing information about a customer, and
iii) a plurality of triggering event records each containing information about a separate triggering event; and
c) a second non-transitory computer readable memory containing programming for:
i) associating the plurality of triggering event records with the professional record,
ii) associating a selected one of the plurality of triggering event records with an activation code,
iii) receiving an activation code from the customer over a computer network,
iv) recording, in the database, information indicating that the customer entered the activation code into an app operating on a mobile device,
v) associating, in the database, the customer record with the selected triggering event record based on the receipt of the activation code from the customer,
vi) associating, in the database, the customer record with the professional record based on the association within the database between the selected triggering event record and the professional record, and
vii) informing the app to present the contact information for the professional to the customer when operating on the mobile device.

22. A computer implemented method comprising:
a) at a server computer, receiving from a remote mobile device an activation code to activate an app running on the remote mobile device;
b) at the server computer, using the activation code to query a database to identify a professional record, wherein the professional record contains information about a professional;
c) at the server computer, using the database to identify an employer record associated with the professional record, wherein the employer record contains information about an employer;
d) at the server computer, using the database to identify a triggering event record;
e) at the server computer, using the database to identify an event sponsor record associated with the triggering event record, wherein the event sponsor record contains information about an event sponsor different than the employer;
f) at the server computer, transmitting to the remote mobile device an activation confirmation and information about the professional, the employer, and the event sponsor, wherein the app on the remote mobile device displays the information about the professional, the employer, and the event sponsor.

23. The computer implemented method of claim 22, wherein the database directly associates the activation code with the triggering event record.

24. The computer implemented method of claim 22, wherein the server computer receives an activation location and an activation time from the remote mobile device when receiving the activation code, further wherein the activation location and the activation time are utilized to identify the triggering event record that has similar time and location parameters.
